(19) United States
(12) Patent Application Publication
(10) Pub. No.: US 2026/0179896 A1
(43) Pub. Date: Jun. 25, 2026

(54) ION OPTICAL ELEMENT AND MASS SPECTROMETER

(71) Applicant: SHIMADZU CORPORATION, Kyoto-shi (JP)

(72) Inventors: Yuki TANAKA, Kyoto-shi (JP); Manabu UEDA, Kyoto-shi (JP); Wataru FUKUI, Kyoto-shi (JP); Kazuki KOMATSU, Kyoto-shi (JP); Hiroki MIYASHIRO, Kyoto-shi (JP)

(21) Appl. No.: 19/404,257

(22) Filed: Dec. 1, 2025

(30) Foreign Application Priority Data
Dec. 19, 2024 (JP) 2024-224111

(51) Int. Cl. H01J 49/06; H01J 49/16; H01J 49/24; H01J 49/42

(52) U.S. Cl. CPC H01J 49/062; H01J 49/165; H01J 49/24; H01J 49/4215

(57) ABSTRACT

An ion optical element comprises: a plurality of rod electrodes, each having a convex portion formed at one end; a plurality of electrode members connected corresponding to each of the plurality of rod electrodes; and a non-conductive base member having a window portion through which ions pass, and fixing the plurality of electrode members and the plurality of rod electrodes at positions surrounding the window portion. Each of the plurality of electrode members has a through hole formed therein. The base member has a concave portion formed therein corresponding to the convex portion. The plurality of electrode members and the plurality of rod electrodes are positioned with respect to the base member by fitting the convex portion into the concave portion through the through hole.

### Technical Field

The present disclosure relates to an ion optical element used in a mass spectrometer and to a mass spectrometer.

### BACKGROUND ART

Mass spectrometers that analyze the mass of ions generated in an ion source are known. Mass spectrometers employ a multi-stage differential pumping system in which a plurality of intermediate vacuum chambers are arranged between an ionization chamber where an ion source is located and a high-vacuum analysis chamber where a mass separator and an ion detector are located. In such mass spectrometers, an ion optical element is used to efficiently converge and transport ions to the next stage in each intermediate vacuum chamber.

Japanese Unexamined Patent Application Publication No. 2023-28190 (Patent Literature 1) discloses four rod electrodes that function as an ion guide, which is an ion optical element, for converging and transporting ions to a subsequent stage.

### CITATION LIST

### Patent Literature

[Patent Literature 1] Japanese Unexamined Patent Application Publication No. 2023-28190

### SUMMARY OF INVENTION

### Technical Problem

If the assembly accuracy of an ion optical element is low, the efficiency of ion convergence to the center of the ion optical axis through which ions pass deteriorates, and the amount of ions transported to the subsequent vacuum chamber decreases. Japanese Unexamined Patent Application Publication No. 2023-28190 discloses reducing manufacturing costs by simplifying the shape of the rod electrodes using a combination of flat surfaces. However, it does not mention improving the assembly accuracy of the ion optical element.

The present disclosure has been made to solve such a problem, and an object thereof is to provide an ion optical element and a mass spectrometer with high assembly accuracy.

### Solution to Problem

The present disclosure relates to an ion optical element used in a mass spectrometer. The ion optical element comprises: a plurality of rod electrodes, each having a convex portion formed at one end; a plurality of electrode members connected corresponding to each of the plurality of rod electrodes; and a non-conductive base member having a window portion through which ions pass, and fixing the plurality of electrode members and the plurality of rod electrodes at positions surrounding the window portion. Each of the plurality of electrode members has a first through hole formed therein. The base member has a first concave portion formed therein corresponding to the convex portion. The plurality of electrode members and the plurality of rod electrodes are positioned with respect to the base member by fitting the convex portion into the first concave portion through the first through hole.

### Advantageous Effects of Invention

According to the present disclosure, the base member has the first concave portion formed therein corresponding to the convex portion of the plurality of rod electrodes. Then, since the plurality of electrode members and the plurality of rod electrodes are positioned with respect to the base member by fitting the convex portion into the first concave portion through the first through hole formed in each of the electrode members, positioning during assembly is simple and accurate, and the assembly accuracy of the ion optical element can be improved.

### BRIEF DESCRIPTION OF DRAWINGS

FIG. 1 is a schematic diagram illustrating an example of the overall configuration of a mass spectrometer.

FIG. 2 is an exploded perspective view showing an ion optical element of an embodiment and an ion optical element of a comparative example.

FIG. 3 is a diagram for explaining the positional relationship between a rod electrode and an electrode member.

FIG. 4 is a cross-sectional view showing the ion optical element of the embodiment and the ion optical element of the comparative example.

FIG. 5 is a graph for explaining the relationship between mass-to-charge ratio and CV value.

### DESCRIPTION OF EMBODIMENTS

The present embodiment will be described in detail with reference to the drawings. Note that identical or corresponding parts in the drawings are denoted by the same reference numerals, and a description thereof will not be repeated in principle.

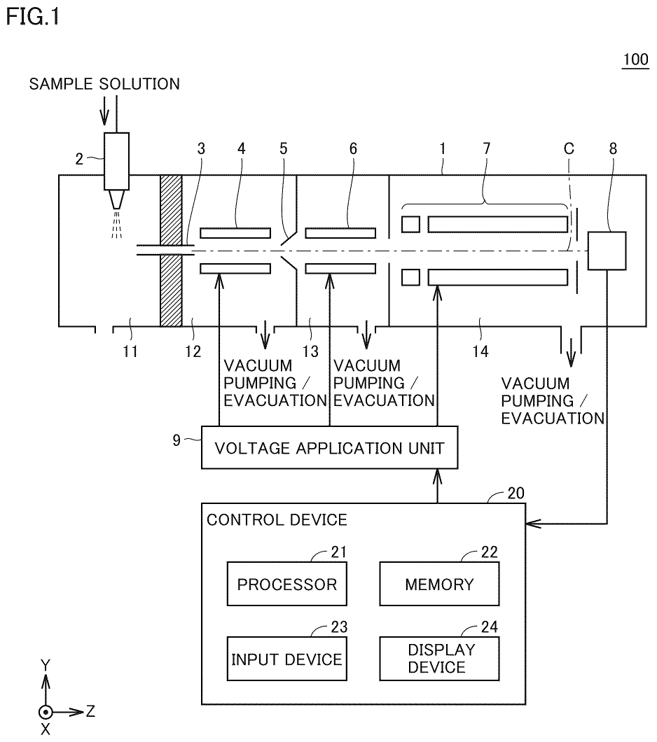

FIG. 1 is a schematic diagram illustrating an example of the overall configuration of a mass spectrometer 100. When the X-axis, Y-axis, and Z-axis are defined as shown in FIG. 1, the X-axis direction is the front-rear direction of the mass spectrometer 100, the Y-axis direction is the up-down direction of the mass spectrometer 100, and the Z-axis direction is the left-right direction of the mass spectrometer 100. The mass spectrometer 100 includes a chamber 1, an ESI (Electrospray Ionization) probe 2, an ion detector 8, a voltage application unit 9, and a control device 20.

The chamber 1 includes an ionization chamber 11, a first intermediate vacuum chamber 12, a second intermediate vacuum chamber 13, and an analysis chamber 14. The ionization chamber 11 is at approximately atmospheric pressure. The first intermediate vacuum chamber 12, the second intermediate vacuum chamber 13, and the analysis chamber 14 are each evacuated by a vacuum pump (not shown). The mass spectrometer 100 has a multi-stage differential pumping system configuration in which the degree of vacuum increases sequentially from the ionization chamber 11 to the first intermediate vacuum chamber 12, the second intermediate vacuum chamber 13, and the analysis chamber 14.

The ESI probe 2 is disposed in the ionization chamber 11. The ESI probe 2 functions as an ion source that ionizes various components contained in a sample solution by spraying the sample solution as minute charged droplets into the ionization chamber 11. The ionization chamber 11 and the first intermediate vacuum chamber 12 are communicated through a thin desolvation capillary 3. Ions generated in the ionization chamber 11 are drawn into the desolvation capillary 3 by a gas flow formed by the pressure difference between both ends of the desolvation capillary 3. The desolvation capillary 3 is heated to a predetermined temperature, and when charged droplets in which the solvent has not sufficiently vaporized are drawn into the desolvation capillary 3, the vaporization of the solvent is promoted as they pass through the desolvation capillary 3, thereby generating ions.

Ion guides 4 and 6, which are ion optical elements, are disposed in the first intermediate vacuum chamber 12 and the second intermediate vacuum chamber 13, respectively. A predetermined voltage is applied from the voltage application unit 9 to each of the plurality of electrodes constituting the ion guides 4 and 6. As a result, an electric field for converging and transporting ions is formed in the space surrounded by the plurality of electrodes. Ions derived from sample components introduced into the first intermediate vacuum chamber 12 are converged by the ion guide 4 and sent to the second intermediate vacuum chamber 13 through a small hole provided at the apex of a skimmer 5. Ions introduced into the second intermediate vacuum chamber 13 are converged by the ion guide 6 and sent to the analysis chamber 14.

In the analysis chamber 14, a quadrupole mass filter 7 and an ion detector 8 are disposed along an ion optical axis C through which ions pass. The quadrupole mass filter 7 includes main rod electrodes, and pre-rod electrodes and post-rod electrodes disposed at its front and rear stages, respectively. A predetermined voltage is applied from the voltage application unit 9 to the plurality of rod electrodes constituting the quadrupole mass filter 7. As a result, an electric field is formed in the analysis chamber 14 that selectively passes ions having a specific mass-to-charge ratio (hereinafter also referred to as “m/z”) (or included in a specific mass-to-charge ratio range) and causes other ions to diverge. Among the various ions introduced into the analysis chamber 14, for example, only ions having a specific mass-to-charge ratio pass through the quadrupole mass filter 7 and reach the ion detector 8.

The ion detector 8 outputs an ion intensity signal corresponding to the amount of incident ions. The ion intensity signal is input to a data processing unit (not shown) of the control device 20, where data processing is performed. For example, by scanning the voltage applied to the electrodes constituting the quadrupole mass filter 7 within a predetermined range, the mass-to-charge ratio of ions that can pass through the quadrupole mass filter 7 changes. The data processing unit can create a mass spectrum showing the change in ion intensity over a predetermined mass-to-charge ratio range.

The control device 20 includes a processor 21, a memory 22, an input device 23, and a display device 24. The processor 21 includes, for example, a CPU (Central Processing Unit). The processor 21 functions as an arithmetic unit that controls the operation of each part of the mass spectrometer 100 by reading out and executing a program stored in the memory 22. For example, the processor 21, by executing the program, controls the voltage application unit 9 to control the voltage applied to each part. Note that although the example in FIG. 1 illustrates a configuration with a single processor 21, the mass spectrometer 100 may have a configuration with a plurality of processors.

The memory 22 is realized by a non-volatile storage device such as a ROM (Read Only Memory) or a hard disk. The memory 22 stores programs executed by the processor 21, data used by the processor 21, and the like. The program may be stored in a non-transitory computer-readable medium.

The input device 23 is typically a mouse, a keyboard, various buttons, a touch panel, or the like. The input device 23 accepts, through user operation, information necessary for controlling the operation of the mass spectrometer 100, information necessary for processing performed by the control device 20, and the like.

The display device 24 is typically a liquid crystal monitor or the like, and displays information input by the user via the input device 23, analysis results, analysis conditions, and the like. Note that the display device 24 may be configured with a printer and paper, and display analysis conditions and the like by printing the analysis results and the like on paper.

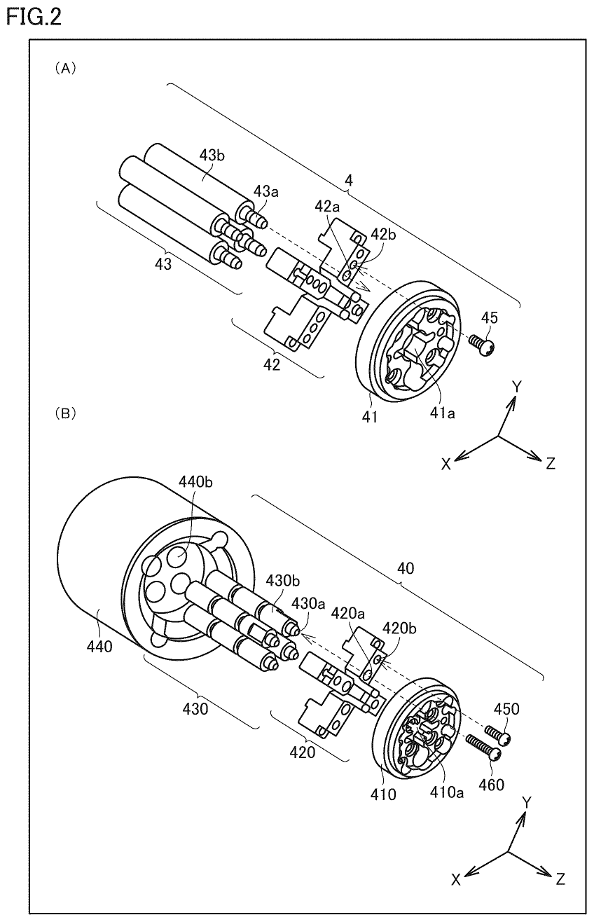

FIG. 2 is an exploded perspective view showing an ion optical element of an embodiment and an ion optical element of a comparative example. FIG. 2(A) shows an ion guide 4, which is the ion optical element of the embodiment, and FIG. 2(B) shows an ion guide 40, which is the ion optical element of the comparative example. The ion guide 40 of the comparative example is an ion optical element structured to be assembled using a jig 440, as described later.

As shown in FIG. 2(B), the ion guide 40 includes a base member 410, four electrode members 420, and four rod electrodes 430. The base member 410 has a window portion 410a formed therein through which ions pass. The electrode member 420 has a through hole 420a and a screw hole 420b formed at a position further outward from the center than the through hole 420a. The rod electrode 430 has a screw hole 430a formed at one end in the positive Z-axis direction of a cylindrical tube portion 430b. The ion guide 40 is assembled using a cylindrical jig 440. The jig 440 has hole portions 440b formed therein for fitting the tube portions 430b of the rod electrodes 430.

The plurality of rod electrodes 430 are positioned with respect to the jig 440 by fitting the tube portions 430b into the bottomed hole portions 440b provided on the jig 440. The electrode member 420 and the rod electrode 430 are fixed at the screw hole 430a at the end of the rod electrode 430 by a screw 460 passing through the base member 410 and the through hole 420a of the electrode member 420. The electrode member 420 is fixed to the base member 410 at the screw hole 420b of the electrode member 420 by a screw 450. The base member 410 is a non-conductive member. The plurality of electrode members 420 and the plurality of rod electrodes 43 are conductive members. The jig 440 is removed after the four electrode members 420 and the four rod electrodes 430 are fixed to the base member 410.

In the ion guide 40, which is the ion optical element shown in FIG. 2(B), since it is assembled using the jig 440, a certain gap is formed between the hole portions 440b of the jig 440 and the tube portions 430b of the rod electrodes 430, which may cause errors during assembly. On the other hand, the ion guide 4, which is the ion optical element of the embodiment, does not use a jig, and thus can reduce errors during assembly. The ion guide 4 will be specifically described.

As shown in FIG. 2(A), the ion guide 4 includes a base member 41, four electrode members 42, and four rod electrodes 43. The base member 41 has a window portion 41a formed therein through which ions pass. The electrode member 42 has a through hole 42a and a screw hole 42b formed at a position further outward from the ion optical axis center than the through hole 42a. The rod electrode 43 has a convex portion 43a formed at one end in the positive Z-axis direction of a cylindrical tube portion 43b.

The base member 41 is a non-conductive member that fixes the plurality of electrode members 42 and the plurality of rod electrodes 43 at positions surrounding the window portion 41a. The plurality of electrode members 42 are connected corresponding to each of the plurality of rod electrodes 43. The electrode members 42 and the rod electrodes 43 are conductive members and are fixed to the base member 41 with a predetermined spacing. The electrode member 42 is fixed to the base member 41 by a screw 45.

Ions ionized in the ionization chamber 11 are converged by an electric field generated by the four rod electrodes 43 and the four electrode members 42 disposed in the first intermediate vacuum chamber 12, and are guided to the second intermediate vacuum chamber 13 at a subsequent stage to the base member 41. Note that the configuration of the ion guide 4 as an ion optical element may also be applied to the ion guide 6 of the second intermediate vacuum chamber 13.

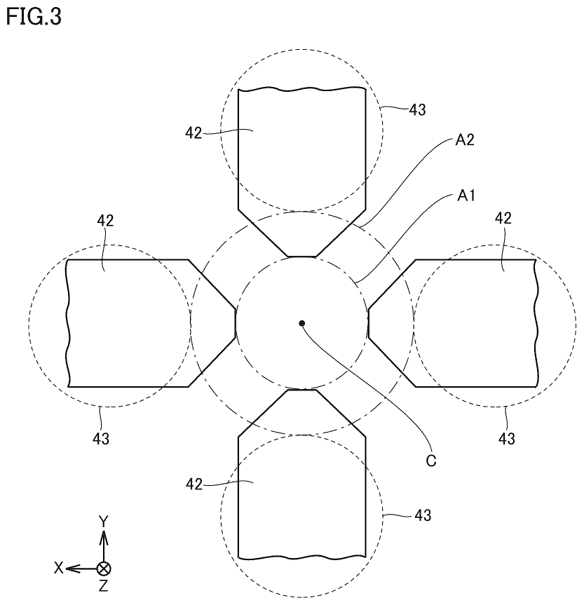

FIG. 3 is a diagram for explaining the positional relationship between the rod electrode 43 and the electrode member 42. As shown in FIG. 3, the rod electrode 43 and the electrode member 42, which are ion optical elements, are disposed every 90 degrees around an ion optical axis C in the Z-axis direction through which ions pass. Note that the shapes and arrangement of the rod electrodes 43 and the electrode members 42 may be changed within a range that does not affect the electric field formed in the space surrounded by the four rod electrodes 43.

Let A1 be a circle tangent to the inner periphery of the electrode members 42 with the ion optical axis C as the center. Let A2 be a circle tangent to the inner periphery of the side surfaces of the rod electrodes 43 with the ion optical axis C as the center. It is desirable that the circles A1 and A2 be true circles with small errors from the ion optical axis C. This is because if the shape of the circles is distorted, the efficiency of ion convergence deteriorates. Therefore, in an ion optical element, accurate positioning of the electrode members 42 and the rod electrodes 43 from the ion optical axis C is important.

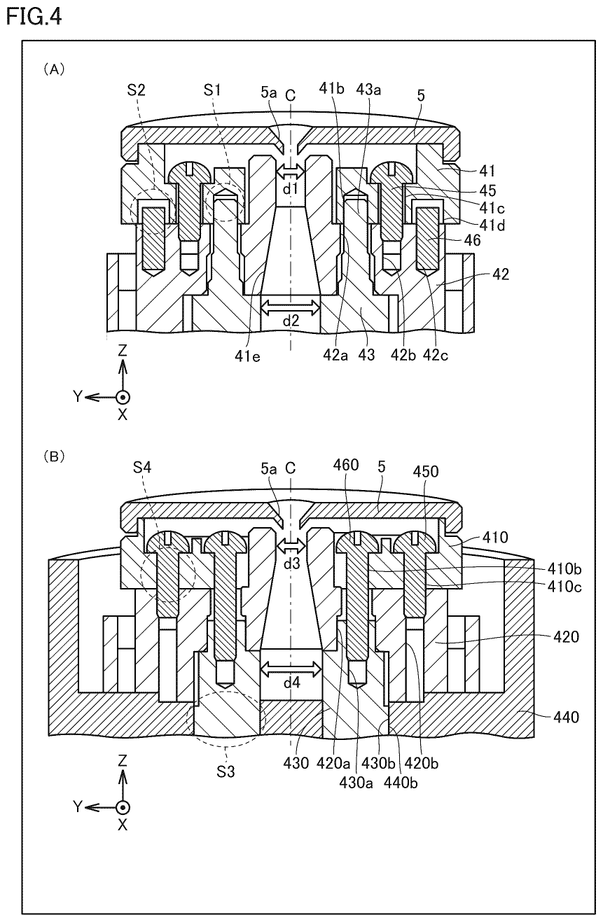

FIG. 4 is a cross-sectional view showing the ion optical element of the embodiment and the ion optical element of a comparative example. FIG. 4(A) shows a cross-sectional view of the ion optical element of the embodiment, and FIG. 4(B) shows a cross-sectional view of the ion optical element of the comparative example. The cross-sectional views in FIG. 4 show cross-sections taken along a YZ plane including the ion optical axis C and two rod electrodes 43 (rod electrodes 430).

As shown in FIG. 4(B), the base member 410 has a through hole 410b and a through hole 410c formed therein. The electrode member 420 has a through hole 420a and a screw hole 420b formed therein. The rod electrode 430 has a screw hole 430a formed at its end in the positive Z-axis direction. The jig 440 has a bottomed hole portion 440b formed therein. The plurality of rod electrodes 430 are screwed to the base member while being fixed to the jig 440. Thereafter, the jig 440 is removed from the plurality of rod electrodes 430.

The electrode member 420 and the rod electrode 430 are fixed to the base member 41 by a screw 460 engaging with the screw hole 430a of the rod electrode 430 through the through hole 410b of the base member 410 and the through hole 420a of the electrode member 420. The tube portion 430b of the rod electrode 430 fits into the hole portion 440b of the jig 440 and is positioned at a position S3.

A screw 450 fixes the base member 410 and the electrode member 420 by engaging with the screw hole 420b of the electrode member 420 through the through hole 410c of the base member 410. In this way, the plurality of electrode members 420 are also positioned with respect to the base member 410 at a position S4 by the screws 450. The skimmer 5 of the comparative example is disposed so as to cover the outer periphery of the base member 410.

Here, the ion optical element of FIG. 4(B) uses the jig 440 for positioning the plurality of rod electrodes 430. The jig 440 requires a gap for removing the jig 440 after fitting the plurality of rod electrodes 430, which may cause errors during assembly. In particular, the ion optical element used as the ion guide 4 has a structure that can be disassembled, cleaned, and reassembled by the user. Therefore, assembly using the jig 440 is highly likely to result in large assembly errors.

Specifically, when using the jig 440, an assembly error may occur in the distance from the ion optical axis C to the tube portion 430b of the rod electrode 430. This may cause an assembly error between the rod electrode 430 and the electrode member 420, which is considered to also cause an assembly error in the distance from the ion optical axis C to the inner periphery of the electrode member 420. That is, using the jig 440 may degrade the overall assembly accuracy of the ion optical element. Furthermore, the side surfaces of the plurality of rod electrodes 430, which are the tube portions 430b, may be damaged by contact with the jig 440 during assembly. Thus, when using the jig 440, the effect of damage to the rod electrodes 430 must be considered, and the tolerance, which is the difference between the maximum and minimum allowable error dimensions, cannot be made strict.

On the other hand, the ion optical element of the embodiment is not assembled using a jig. As shown in FIG. 4(A), the base member 41 has a concave portion 41b, a through hole 41c, and a concave portion 41d formed therein. The through hole 41c is provided as a hole for the screw 45 to pass through between the concave portion 41b and the concave portion 41d. The electrode member 42 has a through hole 42a, a screw hole 42b, and a concave portion 42c formed therein. The rod electrode 43 has a convex portion 43a formed at its end in the positive Z-axis direction. The concave portion 41b of the base member 41 is formed in a shape corresponding to the convex portion 43a of the rod electrode 43.

The electrode member 42 and the rod electrode 43 are positioned with respect to the base member 41 by fitting the convex portion 43a of the rod electrode 43 into the concave portion 41b of the base member 41 through the through hole 42a of the electrode member 42. In this way, the plurality of electrode members 42 and the plurality of rod electrodes 43 are positioned at a position S1.

A screw 45 fixes the base member 41 and the electrode member 42 by engaging with the screw hole 42b of the electrode member 42 through the through hole 41c of the base member 41. A pin 46 is disposed between the concave portion 41d of the base member 41 and the concave portion 42c of the electrode member 42. The pin 46, while being fixed in the concave portion 42c of the electrode member 42, fits into the concave portion 41d of the base member 41, thereby positioning the base member 41 and the electrode member 42. In this way, the plurality of electrode members 42 are also positioned with respect to the base member 41 at a position S2 by the pin 46 fitting into the concave portion 41d.

The skimmer 5 is disposed so as to cover the outer periphery of the base member 41. The skimmer 5 is provided with a small hole 5a centered on the ion optical axis C. Each of the plurality of electrode members 42 is disposed facing each other with the ion optical axis C as the center. On the surface where each of the plurality of electrode members 42 faces, an inclined portion 41e is formed, which inclines from the side surface of the plurality of rod electrodes 43 toward the ion optical axis C.

As shown in FIG. 4(A), let d1 be the distance between the electrode members 42 on the side closer to the skimmer 5, and d2 be the distance between the rod electrodes 43. As shown in FIG. 4(B), let d3 be the distance between the electrode members 420 on the side closer to the skimmer 5, and d4 be the distance between the rod electrodes 430. The diameter of the circle A1 shown in FIG. 3 corresponds to the distance d1, and the diameter of the circle A2 corresponds to the distance d2. As shown in FIG. 3, it is desirable that the circles A1 and A2 be true circles. For this reason, it is desirable that on the XY plane passing through the ion optical axis C, the diameters of the circles (corresponding to distances d1 to d4) have no error depending on the angle from the center of the circle. Since the ion optical element of the embodiment does not use a jig, it can reduce errors in assembly variations and reduce errors in the diameters of the circles.

Specifically, the ion optical element of the embodiment has a structure, as shown in FIG. 4(A), in which the electrode member 42 and the rod electrode 43 are positioned with respect to the base member 41 by fitting the convex portion 43a of the rod electrode 43 into the concave portion 41b of the base member 41 through the through hole 42a of the electrode member 42. In this way, the ion optical element of the embodiment, which does not use a jig, can prevent the rod electrodes 43 from being damaged, simplify and make accurate the positioning during assembly, and improve the assembly accuracy of the ion optical element, as compared to the ion optical element shown in FIG. 4(B) which uses the jig 440.

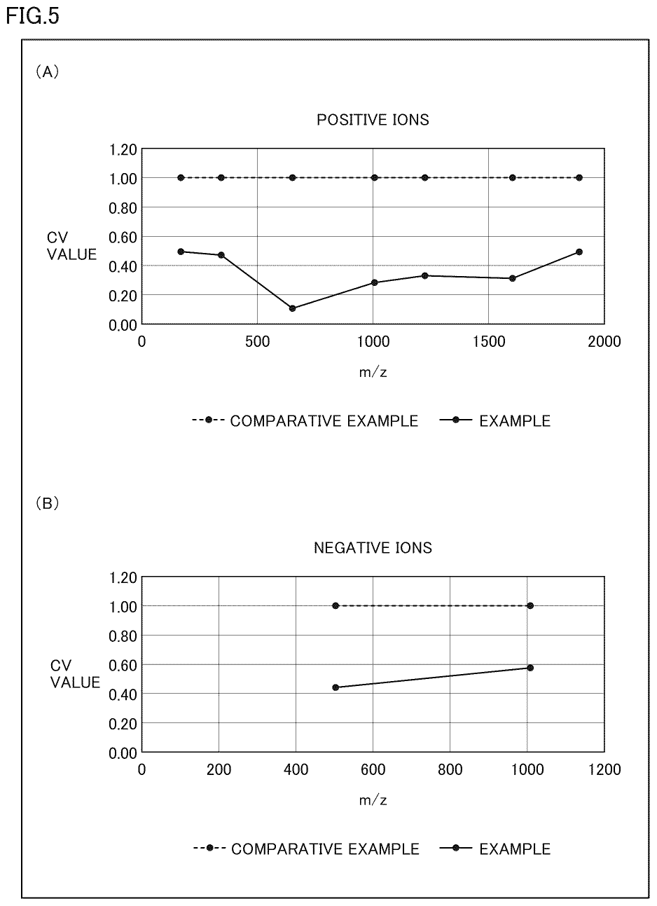

FIG. 5 is a graph for explaining the relationship between mass-to-charge ratio and CV value. The horizontal axis represents the mass-to-charge ratio [m/z], and the vertical axis represents the CV value, which is a dimensionless quantity that is the coefficient of variation. The coefficient of variation is a value obtained by dividing the standard deviation by the mean value and is used as an index indicating the dispersion of data. FIG. 5(A) shows a graph comparing a comparative example and an example for positive ions. FIG. 5(B) shows a graph comparing a comparative example and an example for negative ions.

As shown in FIG. 5(A), for positive ions, when the CV value of the comparative example at each mass-to-charge ratio is taken as 1, the corresponding CV value of the example was lower than that of the comparative example at all mass-to-charge ratios. Similarly, as shown in FIG. 5(B), for negative ions, when the CV value of the comparative example at each mass-to-charge ratio is taken as 1, the corresponding CV value of the example was lower than that of the comparative example at all mass-to-charge ratios.

Thus, it can be said that when the ion optical element of the example is used, the data dispersion is smaller and the assembly accuracy of the ion optical element is improved, compared to when the ion optical element of the comparative example is used. From this, it can be said that when the ion optical element of the example is used, ions can be converged more efficiently than when the ion optical element of the comparative example is used.

### [Modifications]

In the ion optical element of the above-described embodiment, the pin 46 may be fixed to the base member 41 instead of being fixed to the electrode member 42. Alternatively, instead of the pin 46, a protruding portion may be formed from either the electrode member 42 or the base member 41. Furthermore, the pin 46 may be omitted.

### [Aspects]

Those skilled in the art will understand that the exemplary embodiments described above are specific examples of the following aspects.

(First Aspect) An ion optical element according to one aspect relates to an ion optical element used in a mass spectrometer. The ion optical element comprises: a plurality of rod electrodes, each having a convex portion formed at one end; a plurality of electrode members connected corresponding to each of the plurality of rod electrodes; and a non-conductive base member having a window portion through which ions pass, and fixing the plurality of electrode members and the plurality of rod electrodes at positions surrounding the window portion. Each of the plurality of electrode members has a first through hole formed therein. The base member has a first concave portion formed therein corresponding to the convex portion. The plurality of electrode members and the plurality of rod electrodes are positioned with respect to the base member by fitting the convex portion into the first concave portion through the first through hole.

According to the ion optical element of the first aspect, the base member has the first concave portion formed therein corresponding to the convex portion of the plurality of rod electrodes. Then, since the plurality of electrode members and the plurality of rod electrodes are positioned with respect to the base member by fitting the convex portion into the first concave portion through the first through hole formed in each of the electrode members, positioning during assembly is simple and accurate, and the assembly accuracy of the ion optical element can be improved.

(Second Aspect) In the ion optical element according to the first aspect, the base member has a second concave portion formed therein. A pin is disposed on each of the plurality of electrode members. The plurality of electrode members are positioned with respect to the base member by fitting the pin into the second concave portion.

According to the ion optical element of the second aspect, since the positioning of the plurality of electrode members can be performed using pins, positioning during assembly is simple and accurate, and the assembly accuracy of the ion optical element can be improved.

(Third Aspect) In the ion optical element according to the first or second aspect, the plurality of rod electrodes are constituted by four rod electrodes. The plurality of electrode members are constituted by four electrode members corresponding to the four rod electrodes. The four rod electrodes and the four electrode members are disposed every 90 degrees around an ion optical axis through which ions pass.

According to the ion optical element of the third aspect, the four rod electrodes and the four electrode members are disposed every 90 degrees around the ion optical axis through which ions pass. This allows for efficient convergence of ions.

(Fourth Aspect) In the ion optical element according to any one of the first to third aspects, each of the plurality of electrode members is disposed facing each other with the ion optical axis as the center. On the surface where each of the plurality of electrode members faces, an inclined portion is formed, which inclines from the side surface of the plurality of rod electrodes toward the ion optical axis.

According to the ion optical element of the fourth aspect, on the surface where each of the plurality of electrode members faces, an inclined portion is formed, which inclines from the side surface of the plurality of rod electrodes toward the ion optical axis. This allows for efficient convergence of ions.

(Fifth Aspect) The ion optical element according to any one of the second to fifth aspects further comprises a screw for fixing the base member and the plurality of electrode members. The base member has a second through hole formed therein for the screw to pass through between the first concave portion and the second concave portion.

According to the ion optical element of the fifth aspect, the base member and the plurality of electrode members can be appropriately fixed between the first concave portion and the second concave portion.

(Sixth Aspect) A mass spectrometer according to one aspect comprises: an ion source; the ion optical element according to any one of the first to fifth aspects for converging ions generated by the ion source; and an ion detector for detecting ions converged by the ion optical element.

According to the mass spectrometer of the sixth aspect, a mass spectrometer can be provided that includes an ion optical element for which positioning during assembly is simple and accurate, and for which assembly accuracy can be improved.

The embodiments disclosed herein should be considered in all respects as illustrative and not restrictive. The scope of the present disclosure is indicated by the appended claims rather than by the foregoing description of the embodiments, and all changes which come within the meaning and range of equivalency of the claims are intended to be embraced therein.

### REFERENCE SIGNS LIST

1 Chamber, 2 ESI probe, 3 Desolvation capillary, 4, 6, 40 Ion guide, 5 Skimmer, 5a Small hole, 7 Quadrupole mass filter, 8 Ion detector, 9 Voltage application unit, 11 Ionization chamber, 12 First intermediate vacuum chamber, 13 Second intermediate vacuum chamber, 14 Analysis chamber, 20 Control device, 21 Processor, 22 Memory, 23 Input device, 24 Display device, 41, 410 Base member, 41a, 410a Window portion, 41b, 41d, 42c Concave portion, 41c, 42a, 410b, 410c, 420a Through hole, 41e Inclined portion, 42, 420 Electrode member, 42b, 420b, 430a Screw hole, 43, 430 Rod electrode, 43a Convex portion, 43b, 430b Tube portion, 45, 450, 460 Screw, 100 Mass spectrometer, 440 Jig, 440b Hole portion, C Ion optical axis.

1.
An ion optical element used in a mass spectrometer,
the ion optical element comprising:
a plurality of rod electrodes, each having a convex portion formed at one end thereof;
a plurality of electrode members, each connected to each of the plurality of rod electrodes, respectively; and
a non-conductive base member having a window portion through which ions pass, and fixing the plurality of electrode members and the plurality of rod electrodes at positions surrounding the window portion,
wherein each of the plurality of electrode members has a first through hole formed therein,
the base member has a first concave portion formed therein corresponding to the convex portion, and
the convex portion is engaged with the first concave portion through the first through hole, thereby the plurality of electrode members and the plurality of rod electrodes are positioned with respect to the base member.

2. The ion optical element according to claim 1, wherein
the base member has a second concave portion formed therein,
a pin is disposed on each of the plurality of electrode members, and
the plurality of electrode members are positioned with respect to the base member by fitting the pin into the second concave portion.

3. The ion optical element according to claim 1, wherein
the plurality of rod electrodes are constituted by four rod electrodes,
the plurality of electrode members are constituted by four electrode members corresponding to the four rod electrodes, and
the four rod electrodes and the four electrode members are disposed every 90 degrees around an ion optical axis through which ions pass.

4. The ion optical element according to claim 3, wherein
each of the plurality of electrode members is disposed facing each other with the ion optical axis as the center, and
on a surface where each of the plurality of electrode members faces, an inclined portion is formed, which inclines from a side surface of the plurality of rod electrodes toward the ion optical axis.

5. The ion optical element according to claim 2, further comprising a screw for fixing the base member and the plurality of electrode members,
wherein the base member has a second through hole formed therein for the screw to pass through between the first concave portion and the second concave portion.

6. A mass spectrometer comprising:
an ion source;
the ion optical element according to claim 1 for converging ions generated by the ion source; and
an ion detector for detecting ions converged by the ion optical element.
